(19) United States
(12) Patent Application Publication
(10) Pub. No.: US 2008/0161189 A1
(43) Pub. Date: Jul. 3, 2008

(54) Superconducting Electrical Machines

(76) Inventors: Clive Lewis, Warwickshire (GB); Graham LeFlem, Warwickshire (GB)

Correspondence Address: Kirchstein Ottinger Israel & Schhiffmiller, 489 Fifth Avenue, New York, NY, 10017, US

(21) Appl. No.: 11/660,022

(22) PCT Filed: Aug. 8, 2005
(86) PCT No.: PCT/GB05/03096

§ 371 Date: Oct. 8, 2007

(51) Int. Cl. H02K 55/04; H02K 16/02; C04B 35/45

(52) U.S. Cl. 505/121; 505/166; 505/124; 310/52; 310/114; 310/86

(57) ABSTRACT

A superconducting electrical machine has rotor and stator assemblies. A first rotor assembly is located to rotate within a stator assembly and is spaced from the stator assembly by an air gap. A second rotor assembly is located to rotate outside the stator assembly and is also spaced from the stator assembly by an air gap. The first and second rotor assemblies have at least one superconducting field winding. The superconducting field windings are formed from a High Temperature Superconducting (HTS) material such as BSCCO-2223 or YBCO, for example. The double rotor assembly configuration provides a new technical effect over conventional rotating superconducting machines having a single rotor assembly.

### FIELD OF THE INVENTION

The present invention relates to superconducting electrical machines having rotor and stator assemblies, and in particular to such a machine that is suitable for use in applications where low speed and high torque are required in a compact size, such as wind turbine generators and marine propulsion motors.

### BACKGROUND OF THE INVENTION

Rotating superconducting machines are well known. Early machines made use of Low Temperature Superconducting (LTS) materials such as Nb₃Sn and NbTi. More recently, the development of High Temperature Superconducting (HTS) materials such as BSCCO-2223 (Bi₍₂₋ₓ₎PbₓSr₂Ca₂Cu₁₀) and YBCO (YBa₂Cu₃O_{7-ε}) has led to the production of rotating superconducting machines that are more practically implemented.

One manufacturer from which the above-mentioned BSCCO-2223 HTS material is available is American Superconductor (AMSC), HTS Wire Manufacturing Facility of Jackson Technology Park, 64 Jackson Road, Devens, Massachussetts 01434-4020, United States of America.

BSCCO-2223 superconducting cables/tapes can be produced from wires and tapes made of (Bi,Pb)₂Sr₂Ca₂Cu₃O₁₀ filaments in a metal matrix. This material has a superconducting temperature Tc of 10 degrees K. Like other HTS materials, it has a lattice structure consisting of planes of copper-oxygen ions sandwiched between blocks of insulating ions. Hence, the supercurrent is restricted to two-dimensional flow, meaning that the electrical and magnetic properties of HTS materials can depend on their orientation with respect to magnetic or electric fields.

YBCO HTS material becomes superconducting below 90 degrees K. Second-generation HTS wire tape products are being developed at AMSC and other HTS wire manufacturers, and consist of a tape-shaped base, or substrate, upon which a thin coating of YBCO superconductor compound is deposited or grown such that the crystalline lattice of the YBCO in the final product is highly aligned. This creates a coating that is virtually a single crystal coating. The superconductor coating in this “coated conductor” wire architecture typically has a thickness on the order of one micron.

An example of a conventional HTS synchronous machine is described in WO 01/41283 to American Superconducting Corporation. The topology and construction of a known type of HTS synchronous machine is illustrated schematically in FIG. 1, see also “Development Status of Superconducting Rotating Machines”, by Swarn S. Kalsi, presented at IEEE PES Meeting, New York, 27-31 Jan. 2002, IEEE CD Cat#02CH7309C.

A rotor assembly 101 includes a structure 106 for supporting the rotor field windings 108 made of an HTS material such as BSCCO-2223 wire or tape. The support structure 106 and the rotor field windings 108 are located within an annular cryogenic vacuum chamber 110 whose walls 111 are lined with multi-layered insulation 112. Walls 111 are sealingly and securely fixed to the shaft 102 to rotate therewith.

The rotor assembly 101 is mounted in the machine via a torque tube 104, which in turn extends cantilever-fashion from the walls 111 of the vacuum chamber. The torque tube 104 transfers the rotational forces of the rotor assembly to the shaft 102 and is formed of a high-strength material with low thermal conductivity.

A stator assembly 113 outside and surrounding the vacuum chamber 110 includes a tube 114 for supporting the stator armature field windings 116. A rotor back iron 118 is located radially outside the stator assembly to eliminate any stray magnetic flux. An electromagnetic (EM) shield 120 of a non-magnetic material is located between the rotor assembly and the stator assembly. The purpose of the EM shield 120 is to capture any AC magnetic fields from the stator assembly before they reach the rotor field windings 108.

Electrical connectors 122 connect the rotor field windings 108 to an exciter 124 mounted axially alongside the rotor assembly. The exciter 124 supplies an exciter current to the rotor field windings 108 and is of a known brushless type. The rotor assembly, stator assembly and exciter are all mounted within a housing 126.

A cryocooler 128 is mounted outside the housing 126 and a cryogenic cooling loop 130 extends into the support structure 106 to cool the rotor field windings 108 to below their superconducting temperature. Transport of coolant between the stationary cryocooler and the rotor can be achieved by means of ferrofluidic seals, as known. One supplier of such seals is the FerroTec (USA) Corporation, of 40 Simon Street, Nashua, N.H. 03060-3075, USA.

### SUMMARY OF THE INVENTION

The present invention provides a superconducting electrical machine comprising rotor and stator assemblies, wherein:
a first rotor assembly is located to rotate within a stator assembly and is spaced from the stator assembly by a gap; and
a second rotor assembly is located to rotate outside the stator assembly and is spaced from the stator assembly by a gap; and
the rotor assemblies include at least one superconductor field winding arranged for cooling by a cooling system.

The superconductor field windings are preferably formed from a High Temperature Superconducting (HTS) material such as BSCCO or YBCO, for example. Other possible HTS materials include members of the rare-earth-copper-oxide family. It will be readily appreciated that the superconductor field windings can also be formed from a Low Temperature Superconducting (LTS) material such as Nb₃Sn and NbTi or a Medium Temperature Superconducting (MTS) material such as MgB₂ (magnesium diboride).

The double rotor assembly configuration has several advantages over the single rotor assembly used by conventional rotating superconducting machines. Superconducting materials, and particularly HTS materials, have a critical flux density, above which the superconducting properties are lost. The critical flux density depends on the current density and the temperature in the superconducting material. The principal advantage of the double rotor assembly configuration is that it increases the flux density in the stator armature windings while maintaining the flux density in the rotor field windings below the critical flux density, by providing a “push-pull” effect of magnetic flux between the superconducting field windings of the first and second rotor assemblies. The increase in flux density in the armature winding leads to a corresponding increase in the output power of the rotating superconducting machine. It will be readily appreciated that the flux density in the stator armature windings depends on the performance of the superconducting wire or tape that is used to form the superconducting field windings of the first and second rotor assemblies. Conventional HTS synchronous machines using superconducting field windings made of BSCCO-2223 wire or tape can produce armature winding flux densities in the region of from 1.0 to 1.5 Tesla However, the rotating superconducting machine of the present invention can produce flux densities in the region of from 2.0 to 2.25 Tesla using the same or comparable HTS superconducting materials. It is thought that as the performance of HTS superconducting wire and tape continues to improve, the rotating superconducting machine of the present invention will be able to obtain flux densities in the region of from 3.0 to 4.0 Tesla In general, and for rotor field windings formed from the same or comparable superconducting materials, the flux densities produced using the double rotor assembly configuration of the present invention are up to 50% greater than those produced by a single rotor assembly. This means that the rotating superconducting machine of the present invention is smaller and lighter than a conventional rotating superconducting machine having the same power rating.

In conventional rotating superconducting machines the stator armature windings are often surrounded by an iron core (the stator iron), which provides magnetic shielding and a path for the flux. This core is typically laminated and contains AC flux, and hence has hysteresis and eddy current losses. Eddy current losses are particularly significant in the end regions of superconducting machines with air gap windings. In low speed motors, such as marine propulsion motors, the most significant source of acoustic noise is due to alternating magnetic forces action on the stator iron. The iron core is preferably omitted in the rotating superconducting machine according to the present invention, and the active parts of the stator assembly contain no magnetic materials, and no conducting materials apart from the armature windings themselves. This means that the only magnetic forces acting on the stator assembly are those on the armature conductors themselves, and the rotating superconducting machine is extremely quiet. This is important if the rotating superconducting machine is used for marine propulsion applications where low noise is required, such as cruise ships or vessels operating in environmentally sensitive areas.

The rotor poles of the first and second rotor assemblies can include saturated iron members to shape the flux waveform in the stator armature windings. The introduction of the saturated iron members can also help to reduce the number of turns needed in the rotor field windings and/or the stator armature windings.

The stator assembly is preferably mounted on a stator frame.

The first rotor assembly may be directly mounted on the shaft of the superconducting electrical machine, but is preferably mounted on the shaft via a torque tube or other torque transmission arrangement. The second rotor assembly may be directly mounted on a rotor frame, but is preferably mounted on the rotor frame via a torque tube or other torque transmission arrangement. The rotor frame is in turn mounted on the shaft such that the first and second rotor assemblies rotate together. The rotor frame preferably includes a cylindrical portion to which the second rotor assembly is mounted and a radially extending portion that is fixed to the shaft. The cylindrical portion of the rotor frame can be adapted to form a rotor back iron to eliminate any stray magnetic flux. Unlike the stator iron, the rotor back iron would contain DC flux and hence creates no losses or noise.

Electromagnetic (EM) shields can be provided between the first and second rotor assemblies and the stator assembly, respectively in order to shield the superconducting windings from AC flux from the stator armature winding.

The gap between the first rotor assembly and the stator assembly, and between the second rotor assembly and the stator assembly is preferably an air gap.

It is preferred that the cooling system for cooling the superconducting field windings of the first and second rotor assemblies comprises a cryocooler, such as a Gifford-McMahon (G-M or pulse tube cryocooler, and a cryogenic cooling loop extending between the cryocooler and the superconducting field windings.

The superconducting electrical machine preferably also includes an exciter of known type to supply a current to the superconducting field windings. Alternatively, the rotor current could be supplied by sliprings. Apart from preferably being an air gap winding (common to many types of rotating superconducting machines), the stator armature winding circuit is also conventional.

If variable speed operation is required, existing electronics and power converters can be used to control the electrical power supplied to and from the superconducting electrical machine. For example, the power converter can be of a DC link frequency converter type that includes a machine converter, DC link filter, supply converter and an AC output filter. Such a power converter may be implemented using ALSTOM MV7000 products, available from ALSTOM Power Conversion Limited, Marine and Offshore Division, Boughton Road, Rugby, CV211BU, United Kingdom.

The superconducting electrical machine as described above is preferably constituted as an HTS synchronous machine.

The invention also provides a method of operating a superconducting electrical machine comprising rotor and stator assemblies, including the steps of:
locating a first rotor assembly for rotation within a stator assembly and spaced from the stator assembly by a gap; and
locating a second rotor assembly for rotation outside the stator assembly and spaced from the stator assembly by a gap;
cooling at least one superconductor field winding of the rotor assemblies cryogenically; and
rotating the rotor assemblies relative to the stator assembly to operate the machine either as a motor or as a generator.

### BRIEF DESCRIPTION OF THE DRAWINGS

Exemplary embodiments of the invention will now be described, with reference to the accompanying drawings, in which:

FIG. 1 is a schematic view showing the topology of a conventional High Temperature Superconducting (HTS) synchronous machine;

FIG. 2 is a schematic view showing the topology of a HTS synchronous machine according to the present invention and having a double rotor assembly configuration;

FIG. 3 is a cross section view showing the design of a prototype HTS synchronous machine according to the present invention;

FIG. 4 is a cross section view of the prototype HTS synchronous machine of FIG. 3 taken along line B-B;

FIG. 5 is a cut away view of the prototype HTS synchronous machine of FIGS. 3 and 4;

FIG. 6 is a flux line plot for an HTS synchronous machine having a double rotor assembly configuration; and

FIG. 7 is a flux line plot for an HTS synchronous machine having a single rotor assembly configuration.

### DETAILED DESCRIPTION OF SOME PREFERRED EMBODIMENTS

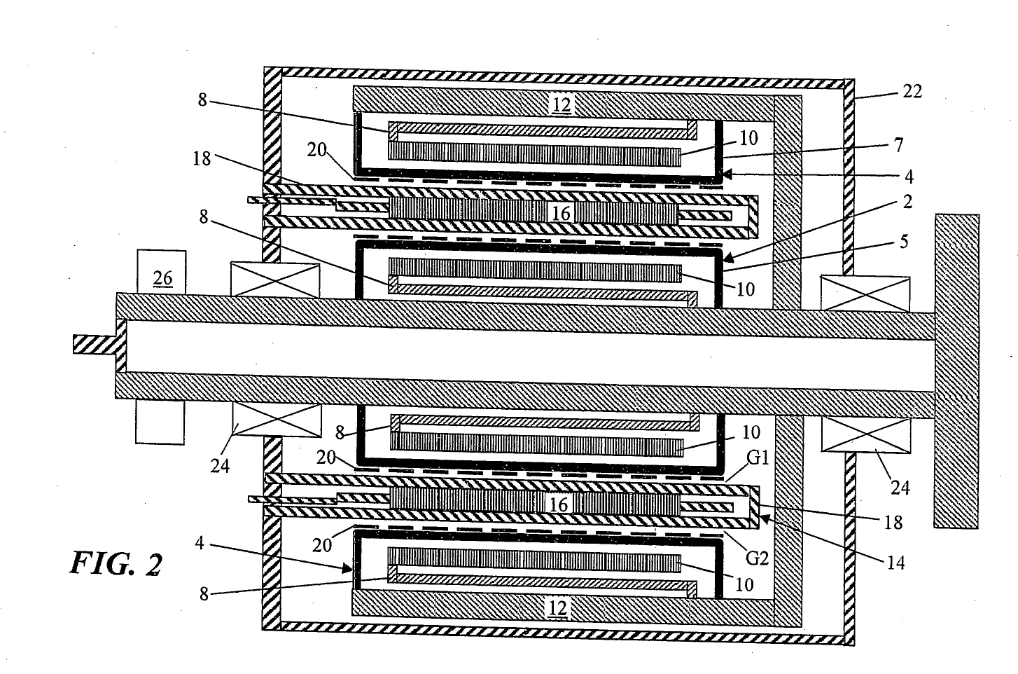

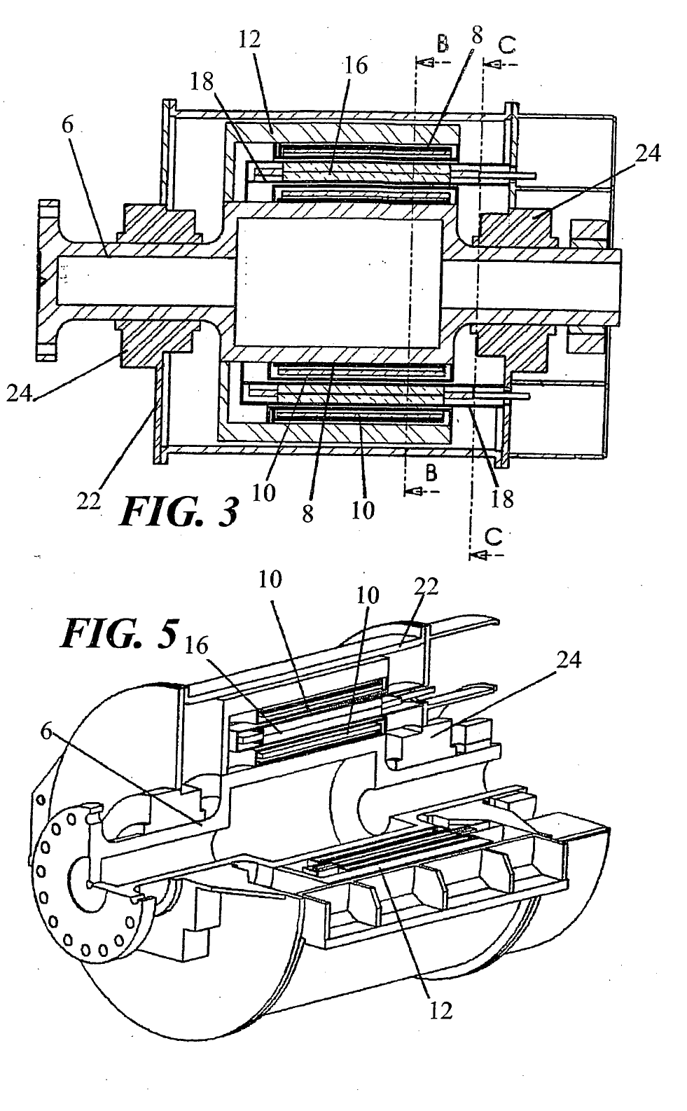

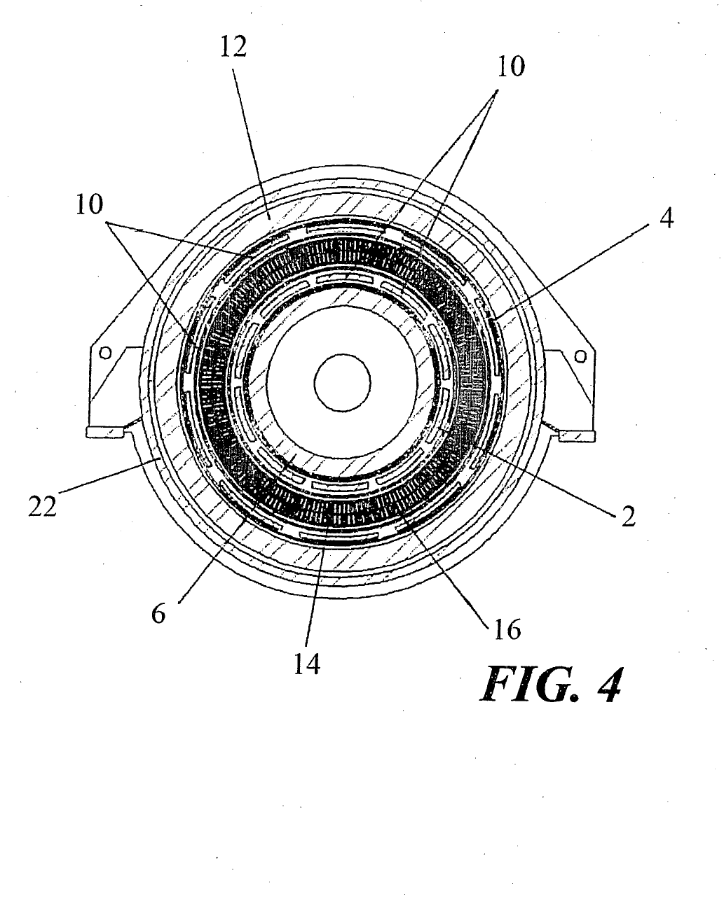

The basic structure of a machine in accordance with the invention will now be described with reference to FIGS. 2 to 5. In FIGS. 3 to 5 the prototype HTS synchronous machine has broadly the same topology as the machine shown schematically in FIG. 2. Consequently, the same reference numerals are used in FIGS. 3 to 5 to indicate machine structure that is equivalent to that shown in FIG. 2.

Referring mainly to FIG. 2, the HTS synchronous machine includes a first (radially inner) annular rotor assembly 2 and a second (radially outer) annular rotor assembly 4. The inner and outer rotor assemblies 2, 4 are enclosed by the insulated walls 5, 7 of respective annular cryogenic vacuum chambers. The walls 5 of the inner cryogenic vacuum chamber are sealingly secured to the main shaft 6, whereas the walls 7 of the outer cryogenic vacuum chamber are sealingly secured to a rotor support structure 12.

In the inner rotor assembly 2, a carrier for a number of field windings 10 is joined to the main shaft 6 of the HTS synchronous machine through a torque tube 8 or other means of transmitting torque. The rotor field windings 10 are made of an HTS material such as BSCCO-2223 wire or tape, for example. In the outer rotor assembly 4, a carrier for a number of field windings 10 is joined to the rotor support structure 12 through a torque tube 8 or other means of transmitting torque, then in turn the rotor support structure 12 is joined to the main shaft 6, so that the first and second rotor assemblies 2 and 4 rotate together.

The cylindrical part of the rotor support 12 that lies radially outside of the second rotor assembly 4 can be made from magnetic iron to eliminate any stray magnetic flux. The field winding of one pole of the machine therefore consists of one coil on the first rotor assembly 2 and one coil on the second rotor assembly 4. A six-pole HTS synchronous machine would therefore have six field coils on the first rotor assembly 2 and six field coils on the second rotor assembly 4.

A stator assembly 14 is located radially between the first and second rotor assemblies 2 and 4. The first, inner rotor assembly 2 is separated from the stator assembly 14 by a first, inner air gap G1 and the second, outer rotor assembly 4 is separated from the stator assembly 14 by a second, outer air gap G2. The stator assembly 14 includes a number of stator coils forming the armature winding 16. These may be positioned inside stator bore tubes 18 in order to provide support and to conduct coolant. The coolant may be gaseous or liquid. Two electromagnetic (EM) shields 20 (shown as dashed lines) may optionally be radially located between the stator assembly 14 and the first and second rotor assemblies 2 and 4 as shown. They would therefore shield the first and second rotor assemblies 2 and 4 from any stray AC magnetic field produced by the stator assembly 14.

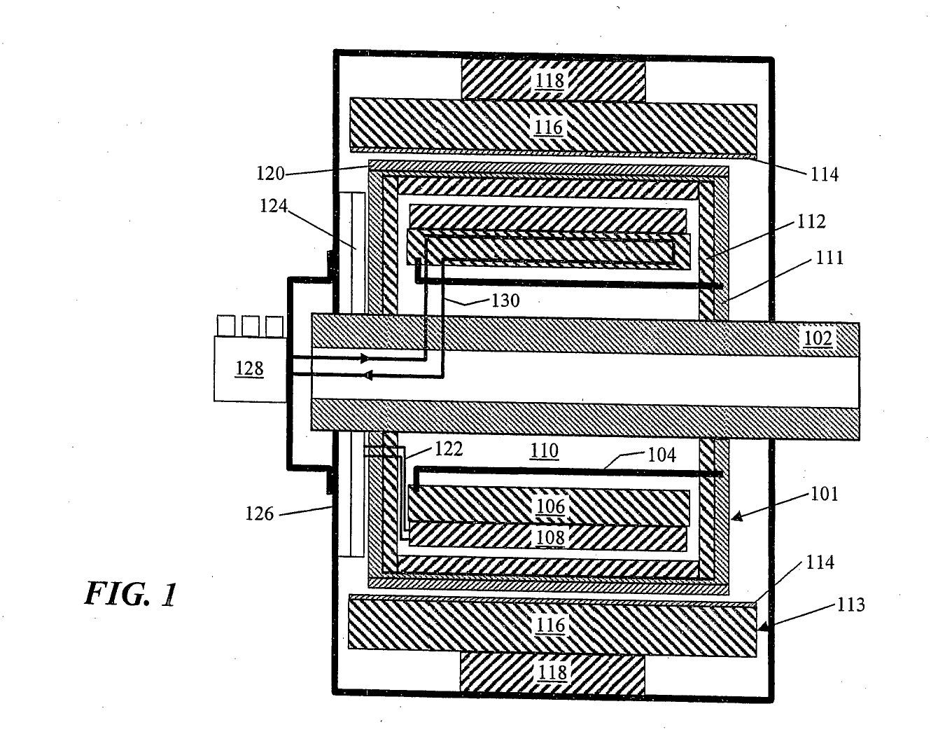

The first and second rotor assemblies 2 and 4, and the stator assembly 14, are enclosed by a stator frame 22. The main shaft 6 is supported on two bearings 24 mounted to the stator frame 22. The HTS synchronous machine may include an exciter 26 of known type to supply an exciter current to the rotor field windings 10. A cooling system as previously described in relation to FIG. 1 is also provided to cool the rotor field windings 10 to below their superconducting temperature.

The prototype HTS synchronous machine shown in FIGS. 3 to 5 is rated at 6 MW, 12 rpm and can be used as a generator in a wind turbine. It is particularly suitable for direct drive wind turbines where the gearbox is omitted and the main shaft 6 of the HTS synchronous machine is coupled directly to the turbine blades, because the HTS synchronous machine can provide high output power even when the main shaft 6 has a low speed of rotation. This prototype HTS synchronous machine is 3.6 m long and the stator frame 22 has an outer diameter of 3.4 m. It is therefore more physically compact and lighter than conventional HTS synchronous machines having a single rotor assembly configuration.

The first and second rotor assemblies include ten pairs of rotor field windings made of BSCCO-2223 tape (although second-generation HTS wire tape products will be used in the future). The rotor field windings 10 of the first (radially inner) rotor assembly are circumferentially spaced around a diameter of 1.82 m. Similarly, the rotor field windings 10 of the second (radially outer) rotor assembly are circumferentially spaced around a diameter of 2.72 m. The armature winding 16 of the stator assembly has an inner and outer diameter of 2.14 m and 2.52 m) respectively. The armature winding 16 is wound using litz wire copper conductors, and the stator assembly does not include an iron core. In fact, the active parts of the stator assembly contain no magnetic materials, and the only conducting material is in the armature windings 16 themselves. This means that the prototype HTS synchronous machine is very quiet, making it highly suitable for marine propulsion applications.

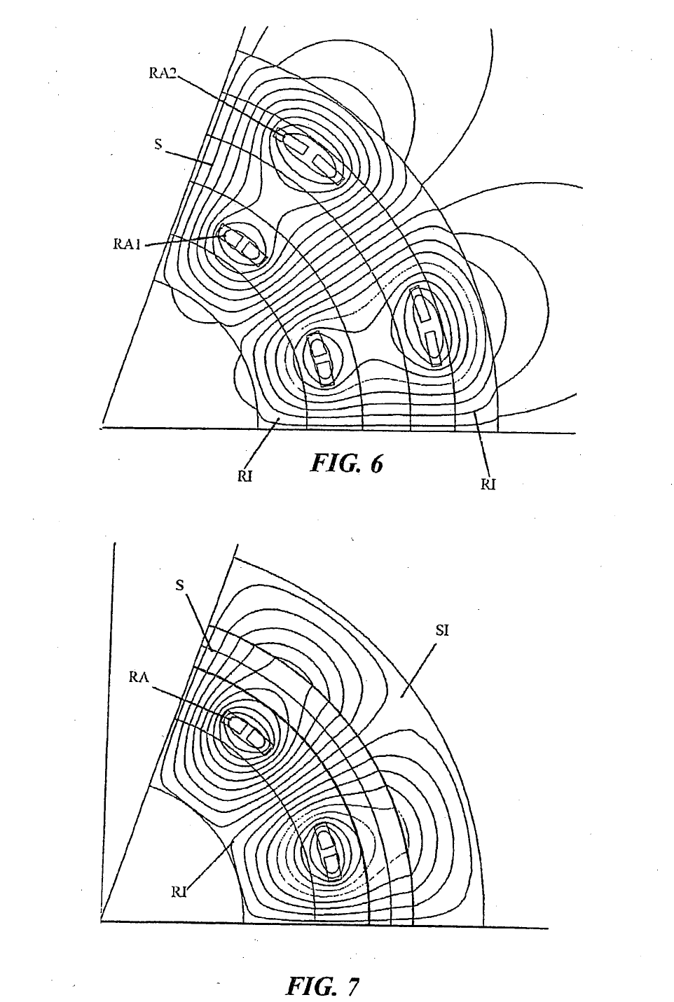

FIG. 6 is a flux line plot for an HTS synchronous machine having a double rotor assembly configuration and a power rating of 6 MW, 12 rpm. The rotor field windings of the first rotor assembly are labelled RA1, the rotor field windings of the second rotor assembly are labelled RA2, the rotor irons are labelled RI and the stator armature winding is labelled S. It can be seen that the flux lines pass through the rotor field windings RA1, the armature winding S and the rotor field windings RA2 in a predominately radial direction. It is the radial component of flux that produces the emf in the axial direction of the armature winding S. Moreover, it is the radial component of flux acting with the current flowing in the axial direction in the armature winding S that creates the torque in the HTS synchronous machine. By comparison, FIG. 7 is a flux line plot for an HTS synchronous machine having a single rotor assembly configuration. The rotor field windings are labelled RA, the rotor iron is labelled RI, the stator armature winding is labelled S and the stator iron is labelled SI.

For the purposes of this comparison, both of the HTS synchronous machines have been selected to have the same external dimensions (in other words, the outside diameter of the rotor iron in the case of the double rotor assembly configuration, and the stator iron in the case of the single rotor assembly configuration, are the same), the same critical flux density in the superconducting materials, and the same current density in the armature winding. Moreover, both flux line plots are based on the projected performance of second-generation HTS wire tape products that will be available in the relatively near future.

The flux line plots indicate that the HTS synchronous machine having the single rotor assembly configuration can only achieve 4.5 MW, 12 rpm and at significantly lower efficiency than the double rotor assembly configuration (97.0% efficiency as compared to 98.2% efficiency for the double rotor assembly configuration). The peak flux density mean through the stator armature winding for the single rotor assembly configuration is 2.27 T. However, the peak flux density mean through the stator armature winding for the double rotor assembly configuration is 3.18 T. This comparison therefore demonstrates that the double rotor assembly configuration is more efficient than the single rotor assembly configuration and is capable of providing a higher power rating when the physical dimensions, critical flux density in the superconducting materials, and the current density in the armature winding are kept constant.

Although the present invention has been described above with reference to an HTS synchronous machine, it will be readily appreciated that the rotor field windings 10 can also be made of an LTS material such as Nb₃Sn and NbTi, or from a Medium Temperature Superconducting (MTS) material such as MgB₂ (magnesium diboride).

1-27. (canceled)

28. A superconducting electrical machine comprising rotor and stator assemblies, comprising:
a first rotor assembly located to rotate within a stator assembly and spaced from the stator assembly by a gap; and
a second rotor assembly located to rotate outside the stator assembly and spaced from the stator assembly by a gap;
wherein the rotor assemblies include at least one superconductor field winding arranged for cooling by a cooling system.

29. The superconducting electrical machine according to claim 28, wherein the superconductor field windings are formed from a High Temperature Superconducting (HTS) material.

30. The superconducting electrical machine according to claim 29, wherein the HTS material is BSCCO.

31. The superconducting electrical machine according to claim 29, wherein the HTS material is YBCO.

32. The superconducting electrical machine according to claim 28, wherein the superconductor field windings are formed from a Low Temperature Superconducting (LTS) material.

33. The superconducting electrical machine according to claim 32, wherein the LTS material is Nb3Sn.

34. The superconducting electrical machine according to claim 32, wherein the LTS material is NbTi.

35. The superconducting electrical machine according to claim 28, wherein the superconductor field windings are formed from a Medium Temperature Superconducting (MTS) material.

36. The superconducting electrical machine according to claim 35, wherein the MTS material is MgB2.

37. The superconducting electrical machine according to claim 28, wherein the stator assembly further includes a stator armature winding and the first and second rotor assemblies include rotor poles having saturated iron members to shape the flux waveform in the stator armature windings.

38. The superconducting electrical machine according to claim 28, wherein the stator assembly is mounted on a stator frame.

39. The superconducting electrical machine according to claim 28, wherein the stator assembly has no iron in the magnetic circuit.

40. The superconducting electrical machine according to claim 28, wherein the superconducting electrical machine includes a shaft and the first rotor assembly is mounted on the shaft.

41. The superconducting electrical machine according to claim 40, wherein the first rotor assembly is mounted on the shaft of the rotating superconducting machine through a torque tube.

42. The superconducting electrical machine according to claim 28, wherein the superconducting electrical machines includes a shaft and the second rotor assembly is mounted on a rotor frame.

43. The superconducting electrical machine according to claim 42, wherein the second rotor assembly is mounted on the rotor frame through a torque tube.

44. The superconducting electrical machine according to claim 42, wherein the rotor frame is mounted on the shaft such that the first and second rotor assemblies rotate together.

45. The superconducting electrical machine according to claim 42, wherein the rotor frame includes a cylindrical portion on which the second rotor assembly is mounted and a radially extending portion that is fixed to the shaft.

46. The superconducting electrical machine according to claim 45, wherein the cylindrical portion of the rotor frame is made of magnetic iron to eliminate any stray magnetic flux.

47. The superconducting electrical machine according to claim 28, wherein an electromagnetic (EM) shield is provided between the first rotor assembly and the stator assembly.

48. The superconducting electrical machine according to claim 28, wherein an electromagnetic (EM) shield is provided between the second rotor assembly and the stator assembly.

49. The superconducting electrical machine according to claim 28, wherein the gap between the first rotor assembly and the stator assembly is an air gap.

50. The superconducting electrical machine according to claim 28, wherein the gap between the second rotor assembly and the stator assembly is an air gap.

51. The superconducting electrical machine according to claim 28, further comprising an exciter to supply an exciter current to the superconducting field windings.

52. A method of operating a superconducting electrical machine comprising rotor and stator assemblies, comprising the steps of:
locating a first rotor assembly for rotation within a stator assembly and spaced from the stator assembly by a gap; and
locating a second rotor assembly for rotation outside the stator assembly and spaced from the stator assembly by a gap;
cooling at least one superconductor field winding of the rotor assemblies cryogenically; and
rotating the rotor assemblies relative to the stator assembly.

53. The method according to claim 52, wherein the step of rotating the first and second rotor assemblies relative to the stator assembly is achieved by electrically exciting the at least one superconductor field winding for operation of the superconducting electrical machine as a motor.

54. The method according to claim 52, wherein the step of rotating the first and second rotor assemblies relative to the stator assembly is achieved by application of torque to the shaft of the superconducting electrical machine for operation of the superconducting electrical machine as a generator.
